(19) United States
(12) Patent Application Publication
(10) Pub. No.: US 2008/0151411 A1
(43) Pub. Date: Jun. 26, 2008

(54) Startup processing method for medium storage device, controller for medium storage device, and medium storage device

(75) Inventor: Keiichi Yorimitsu, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/002,572

(22) Filed: Dec. 18, 2007

(30) Foreign Application Priority Data
Dec. 26, 2006 (JP) 2006-349445

(51) Int. Cl. G11B 21/02

(52) U.S. Cl. 360/75

(57) ABSTRACT

A medium storage device performs ready processing for enabling a head to access data on a storage medium after power is turned ON, in order to prevent to change the status to offline by the host even if ready time is delayed due to retry. The medium storage device has a rotary storage medium, a head, a control unit, and a memory for storing a specified ready time at which the ready processing is expected to be completed. And the command response of the device is changed to ready status when the specified ready time comes even if the ready processing is not complete within the specified ready time. Therefore when the host issues an access command after the specified ready time elapses, since Ready is responded, the possibility of the host changing the status to offline is eliminated.

### CROSS-REFERENCE TO RELATED APPLICATIONS

This application is based upon and claims the benefit of priority from the prior Japanese Patent Application No. 2006-349445, filed on Dec. 26, 2006, the entire contents of which are incorporated herein by reference.

### BACKGROUND OF THE INVENTION

1. Field of the Invention

The present invention relates to a medium storage device which rotates a storage medium and reads data on the storage medium using a head, a controller for the medium storage device, and ready (start up) processing method for the medium storage device, and more particularly to a medium storage device which rotates a storage medium after power is turned ON, enables a head read and write operation and accepts access from a host, a controller for the medium storage device and a ready processing method for the medium storage device.

2. Description of the Related Art

As a storage device connected to the host, a disk device of which storage medium is a rotating body is widely used. The disk device requires the following startup processing (ready processing) to enable medium access from the host after power is turned ON (e.g. Japanese Patent Application Laid-Open No. H9-54742).

(1) Micro code is read from the BOOT/flash memory, for example, to a program area, such as SRAM (Static Random Access Memory).

(2) A spindle motor for rotating a disk medium is started up.

(3) The system waits until the rotation of the spindle motor becomes steady.

(4) The head is moved from either the CSS (Contact Start Stop) zone or lamp to a system area on the rotating disk medium, and the head reads setting information (e.g. drive parameter, mode parameter information, defect position information, zone-format information) from the system area.

Then commands from the host are received. This processing is expected to be completed normally within 20 to 30 seconds.

If a minor spindle motor failure, for example, occurs, during startup processing of the disk device, a spin up retry is performed in the device. In the case of head absorption, for example, the head is moved (compress processing) and retry is performed. By this, the status of the disk device can be recovered.

After spin up succeeds, the head seeks and reads the system area since the disk configuration information of the disk is recorded in the system area (SA area) on the medium surface. This positioning and reading, however, may fail because of a servo failure and medium failure. To handle such a status, information in the system area has been written by a multiple information, and is often recoverable by a retry using information in another system area.

For this retry, retry processing onboard the hard disk drive is activated, and as a result startup of the device delays for the time required for retry. In particular, in the case of a device which mounts a plurality (e.g. 4) of disk media, retry of spin up could take 10 or more seconds.

Normally power of the hard disk connected to the host is supplied from the system, and an operating system (OS) at the host side knows the power supply time for the hard disk drive.

Normally an OS operates expecting that the hard disk drive can be accessed for reading/writing when a predetermined time (e.g. 30 seconds) has elapsed after power is turned ON. For example, when 30 seconds have elapsed after power is turned ON, the host sends a command for status confirmation command (e.g. inquiry command) or a read/write command to the hard disk drive.

Although this depends on the configuration of the OS, when the ready processing of the disk device cannot be completed in 30 seconds and the disk device responds to an access command with an error message, such as “Not Ready”, in many cases the host regards this as a serious failure to the hard disk drive, and disables the use of the hard disk drive (offline). Particularly in the case of a storage system connected to the host, the controller connects several hundred or several thousand disk drives, and the OS of the host cannot wait because of the delay of ready processing of an individual disk drive.

Therefore even if the hard disk device is recovered by an internal retry after this, the system continues to recognize the disk device as offline. Particularly in the case of a storage system where the host is connected with many disk devices, a disk drive is returned to online status by the manual intercession of a system operator, or a disk device is returned to the vendor as a device to which serious failure occurred.

Some users specify within a 30 seconds response to a command from the host, as a required specification of a hard disk device.

### SUMMARY OF THE INVENTION

With the foregoing in view, it is an object of the present invention to provide a start up processing method for a medium storage device, a controller for the medium storage device, and a medium storage device for preventing a delay of medium access from the host, even if ready processing delayed due to such a reason as a retry.

It is another object of the present invention to provide a start up processing method for a medium storage device and a medium storage device for preventing the host from changing the status to offline even if ready processing delays, due to such reason as a retry, while off line.

It is still another object of the present invention to provide a start up processing method for a medium storage device, a controller for the medium storage device, and a medium storage device for preventing the delay of medium access from the host even if ready processing delays, due to such reason as retry, and reporting an error to a medium access command when retry processing does not succeed.

It is still another object of the present invention to provide a start up processing method for a medium storage device, a controller for the medium storage device, and a medium storage device for receiving a medium access command from the host even if ready processing delays, due to such reason as retry, and reporting an error to a medium access command when retry processing does not succeed.

To achieve these objects, a medium storage device of the present invention has: a spindle motor for rotating a storage medium; a head for at least reading data from the rotating storage medium; and a control unit which executes ready processing for enabling the head to access the storage medium after power is turned ON, executes retry of the ready processing if the ready processing does not succeed, and accepts a command from a host and enters ready status for executing the command if the ready processing succeeds, wherein the control unit stores a specified ready time, at which a predetermined ready processing is expected to be completed after power is turned ON, and receives and accepts a command from the host if the ready processing does not succeed even when the specified ready time elapses.

A controller for a medium storage device of the present invention has: a control unit which executes ready processing for enabling the head to access the storage medium after power is turned ON, executes retry of the ready processing if the ready processing does not succeed, and accepts a command from a host and enters the ready status for executing the command if the ready processing succeeds; and a memory for storing a specified ready time at which a predetermined ready processing is expected to be completed after the power is turned ON, wherein the control unit receives and accepts a command from the host if the ready processing does not succeed even when the specified ready time in the memory elapses.

A startup processing method for a medium storage device of the present invention, has the steps of: executing ready processing for enabling the head to access the storage medium after power is turned ON; executing retry of the ready processing if the ready processing does not succeed; accepting a command from a host and executing the command if retry processing succeeds; and receiving and accepting a command from the host if the ready processing does not succeed even when a specified ready time, at which a predetermined ready processing is expected to be completed after power is turned ON, elapses.

In the present invention, it is preferable that the control unit stores a maximum delay time, and suspends execution of the accepted command until the maximum delay time elapses if the ready processing does not succeed before the maximum delay time elapses.

In the present invention, it is also preferable that the control unit judges whether the accepted command is a medium access command for accessing the storage medium, and suspends execution of the accepted command until the maximum delay time elapses if the accepted command is the medium access command.

In the present invention, it is also preferable that the control unit reports an error to the host about the accepted command if the ready processing does not succeed before the maximum delay time elapses.

In the present invention, it is also preferable that the control unit executes the accepted command if the ready processing succeeds before the maximum delay time elapses.

In the present invention, it is also preferable that the control unit has a queue buffer for queuing the accepted command, and stores the command accepted after the specified ready time and before the maximum delay time in the queue buffer with a temporal receive identifier attached.

In the present invention, it is also preferable that the control unit creates a command information table of the command when the command is accepted from the host, and sets the temporal receive identifier and a command restart time to indicate the maximum delay time of the command in the command information table.

In the present invention, it is also preferable that the control unit judges whether the accepted command is a medium access command for accessing the storage medium, and executes the accepted command before the maximum delay time elapses if the accepted command is not the medium access command.

A specified ready time, at which the ready processing is expected to be completed, is set, and the command response of the device is changed to ready status when the specified ready time elapses, even if the ready processing is not complete within the specified ready time. Therefore when the host issues an access command after the specified ready time elapses, “Ready” is responded, and the host does not change the status to offline. If the ready processing still is not complete even if the maximum delay time elapses, the command response becomes “Not Ready” again. Therefore the host can recognize a failure of ready processing by a command response.

### BRIEF DESCRIPTION OF THE DRAWINGS

FIG. 1 is a block diagram depicting a medium storage device according to an embodiment of the present invention;

FIG. 2 is a diagram depicting the command management table in FIG. 1;

FIG. 3 is a diagram depicting the command information table in FIG. 1;

FIG. 4 is a first diagram depicting the ready processing and the command response processing according to an embodiment of the present invention;

FIG. 5 is a second diagram depicting the ready processing and the command response processing according to an embodiment of the present invention;

FIG. 6 is a third diagram depicting the ready processing and the command response processing according to an embodiment of the present invention;

FIG. 7 is a fourth diagram depicting the ready processing and the command response processing according to an embodiment of the present invention;

FIG. 8 is a flow chart depicting power ON processing according to an embodiment of the present invention;

FIG. 9 is a flow chart (part 1) depicting the command receive processing according to an embodiment of the present invention;

FIG. 10 is a flow chart (part 2) depicting the command receive processing according to an embodiment of the present invention; and

FIG. 11 is a flow chart depicting the idle processing according to an embodiment of the present invention;

### DESCRIPTION OF THE PREFERRED EMBODIMENTS

Embodiments of the present invention will now be described in the sequence of a medium storage device, response in ready processing, ready processing and other processing, but the present invention is not limited to these embodiments.

### Medium Storage Device

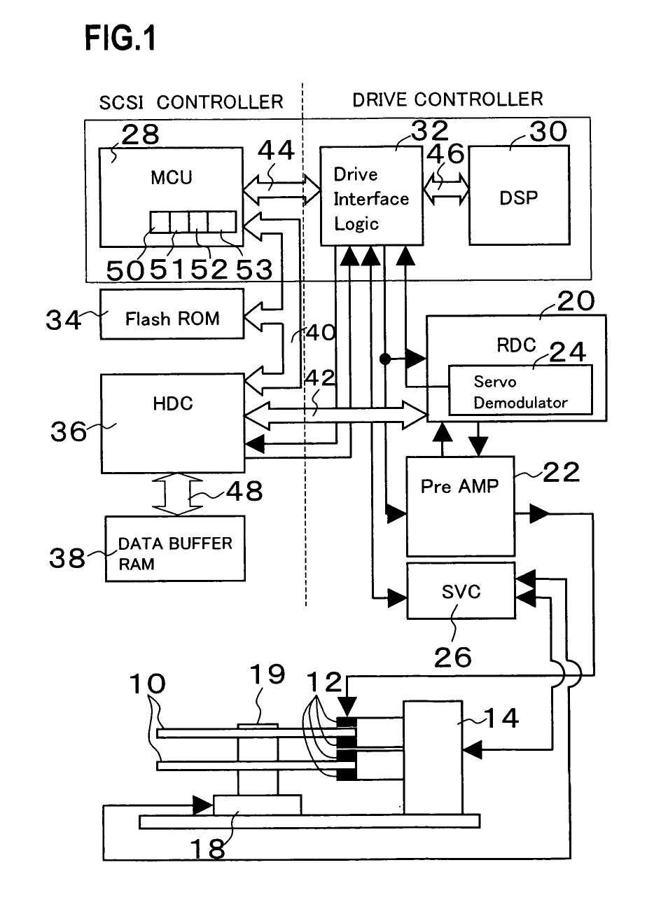

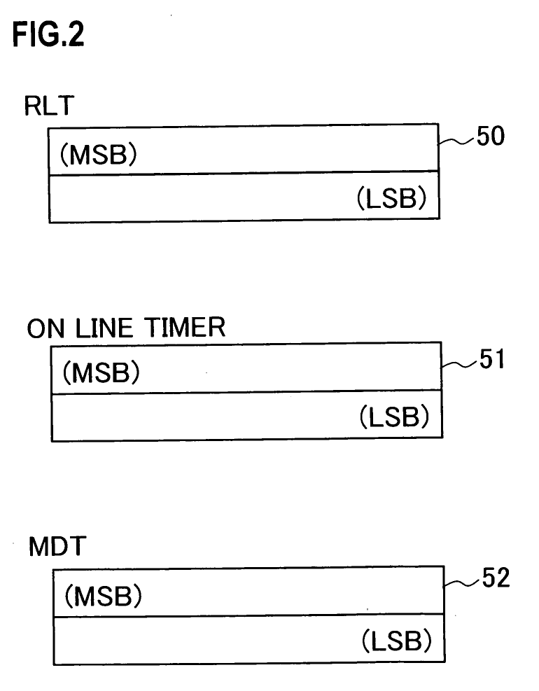

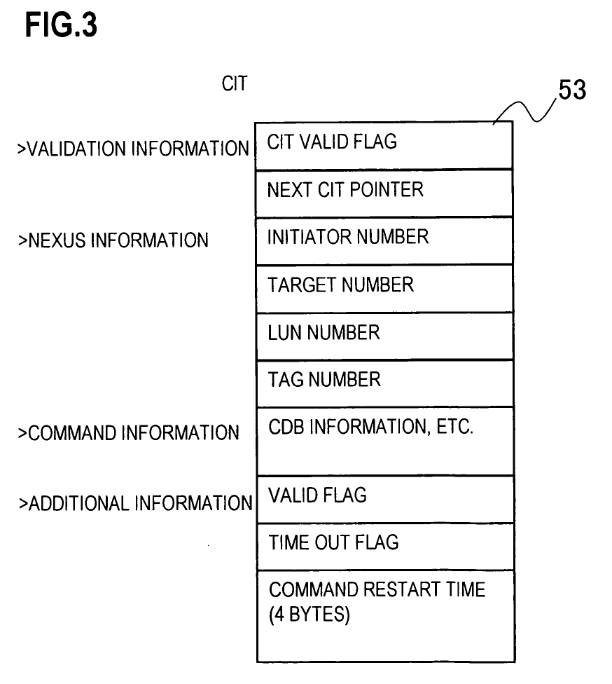

FIG. 1 is a block diagram depicting a medium storage device according to an embodiment of the present invention, FIG. 2 is a diagram depicting the command processing table in FIG. 1, and FIG. 3 is a diagram depicting the command information table in FIG. 1.

FIG. 1 shows a magnetic disk device as a medium storage device. As FIG. 1 shows, magnetic disks 10, which are magnetic storage media, are installed at a rotation axis 19 of a spindle motor 18. The spindle motor 18 rotates the magnetic disk 10. An actuator (VCM) 14 has magnetic heads 12 at the tip, and moves the magnetic heads 12 in a radius direction of the magnetic disk 10.

The actuator 14 comprises a voice coil motor (VCM) which rotates on the rotation axis. In FIG. 1, 2 magnetic disks 10 are installed in the magnetic disk device, and 4 magnetic heads 12 are simultaneously driven by the same actuator 14.

The magnetic head 12 comprises read elements and write elements. The magnetic head 12 is constituted such that read elements including magneto-resistance (MR) elements are stacked in the slider, and write elements including a write coil are stacked thereon.

A preamplifier 22 sends a write signal to the magnetic head 12, and amplifies a read signal of the magnetic head 12. A servo combo circuit 26 drives the spindle motor 18, and supplies drive current to the voice coil motor (VCM) 14 to drive the VCM 14.

A read channel circuit 20 demodulates a position of the magnetic head 12 based on the servo signals among the read signals from the preamplifier 22. A controller comprises a microcontroller (MCU) 28, a DSP (Digital Signal Processor) 30 and a drive interface circuit 32.

The DSP 30 detects a current position based on the demodulated position from the read channel circuit 20, and computes a VCM drive command value according to an error of the detected current position and the target position. In other words, the DSP 30 performs servo control including seeking and following.

The MCU 28 comprises an MPU, ROM and RAM, where the read only memory (ROM) stores control programs of the MPU, for example, and the random access memory (RAM) stores data for the processing of the MPU, for example. This MCU 28 performs later mentioned ready processing and retry processing after power is turned ON.

The drive interface circuit 32 forms a bridge between the drive side circuits (read channel 20, preamplifier 22, servo combo circuit 26), and the MCU 28 and the DSP 30, and is connected with the MCU 28 via a first internal bus 44 and with the DSP 30 via a second internal bus 46.

A flash ROM (Read Only Memory) 34 stores a boot program, such as micro code. A hard disk controller (HDC) 36 judges a position on a track based on a sector number of a servo signal, and instructs the read channel 20 to record/regenerate data.

A buffer random access memory (RAM) 38 is connected to the HDC 36 via a memory bus 48, and temporarily stores read data and write data. The HDC 36 communicates with the host via such an interface IF as USB (Universal Serial Bus), ATA (AT Attached) and SCSI (Small Component System Interface). A bus 40 connects the MCU 28, flash ROM 34 and HDC 36. The HDC 36 is connected to the read channel 20 via a data bus 42 for exchanging read and write data.

In the configuration in FIG. 1, the HDC 36 exchanges data with the host and drive, the DSP 30 performs seek and following control of the magnetic head 12, and the MCU 28 performs processing for controlling each section according to a command received by the HDC 36.

FIG. 2 is a diagram depicting a command processing table created in the MCU 28, and FIG. 3 is a diagram depicting a command information table created in the MCU 28.

As FIG. 2 shows, a retry time table 50 is a table for storing a maximum retry allowable time (recovery limited time) RLT per command. The host calculates the expected completion time of this command by “command execution time+retry allowable time+α”. In other words, this expected time is the time out time of the command, which has been set conventionally.

The online timer 51 and the maximum delay timer 52 in FIG. 2 and the command information table 53 in FIG. 3 are tables newly added to an embodiment of the present invention. The online timer (ONLT) 51 stores a specified ready time of this system. This time can be set to an arbitrary value by a host command. The default value is 30 seconds, for example.

The maximum delay timer (MDT) 52 stores the maximum delay time of the start of command execution. This time can be set to an arbitrary value by the host command. This time, however, should be lesser than the recovery limit time RLT. In this case, RLT is set even if a value more than the recovery limit time RLT is set for the maximum delay time. The default value is 15 seconds, for example.

The command information table 53 (CIT) in FIG. 3 is a table generated for each command when a command is received. The command information table 53 stores a valid flag of the CIT, the next CIT pointer, initiator number, target number, LUN number, Tag number and command information (CDB information).

In the present embodiment, extra information is added to the command information table 53. The added information is a valid flag, time out flag and command restart time.

When the valid flag is “1”, this indicates that this command is a temporarily received command in a Not Ready Status. When the time out flag is “1”, this indicates that a time out occurred to the command temporarily received in Not Ready Status, since the device did not become ready even if the maximum delay time MDT has elapsed.

The command restart time indicates the final time when the command execution can be restarted. If the device does not become ready even if this time comes, a time out flag is set, and the command ends in error.

Because of using this table, even if a command is received before ready completion and ready completion delayed due to a retry, for example, the possibility of the host changing the status to offline is decreased, and stable operation is enabled.

Response in Ready Processing

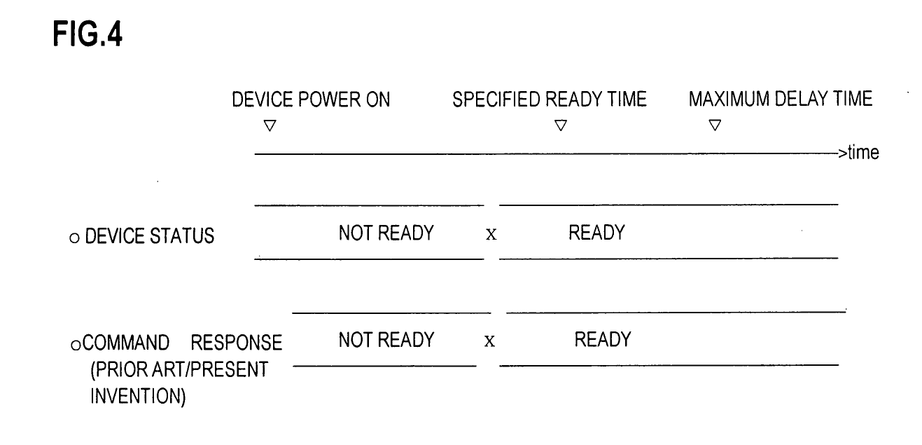

FIG. 4 to FIG. 7 shows the response in ready processing of an embodiment of the present invention in comparison with a prior art. FIG. 4 shows a device status and command response when the device ready processing is complete within a specified ready time ONLT specified by an online timer 51 from when power is turned ON.

As FIG. 4 shows, if the device ready processing is complete within the specified ready time ONLT and the devices status changes from Not Ready to Ready before the specified ready time elapses, the command response of the present invention changes from Not Ready to Ready when the device status changes from Not Ready to Ready, just like the case of the prior art.

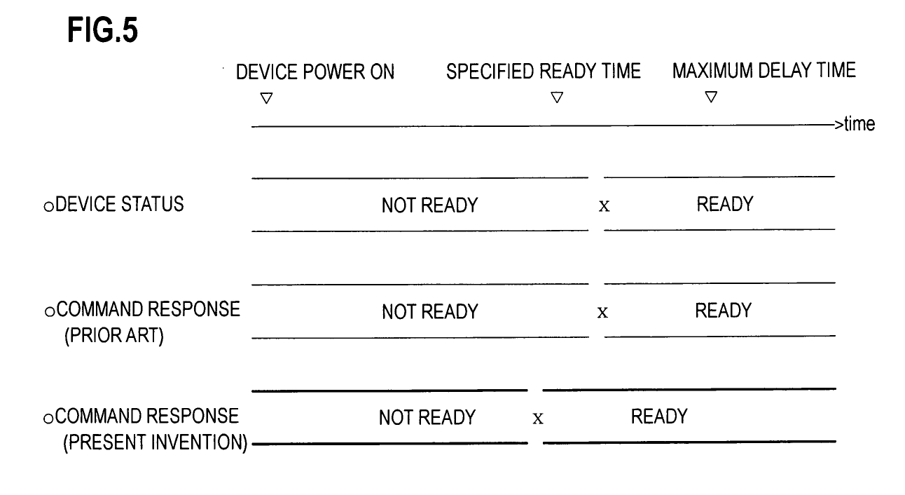

As FIG. 5 shows, if the device ready processing is complete after the specified ready time ONLT and within a maximum delay time MDT specified by a maximum delay timer 52, the device status changes from Not Ready to Ready after the specified ready time ONLT before the maximum delay time MDT.

In this case, according to the prior art, the command response changes from Not Ready to Ready when the device status changes from Not Ready to Ready. According to the present invention, however, the command response changes from Not Ready to Ready at the specified ready time ONLT.

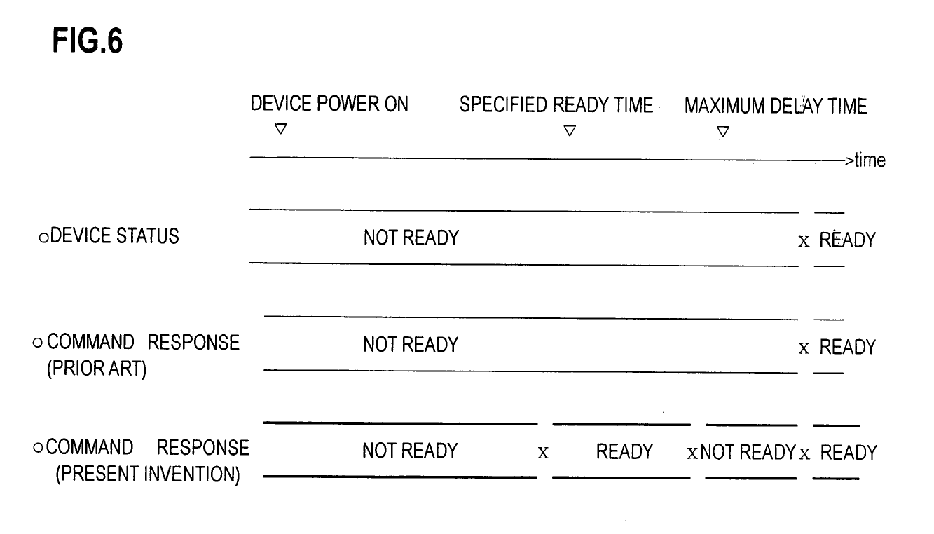

As FIG. 6 shows, if the device ready processing is not complete after the specified ready time ONLT and within the maximum delay time MDT specified by the maximum delay timer 52, the device status changes from Not Ready to Ready when the specified ready time ONLT is exceeded and after the maximum delay time MDT elapses.

In this case, according to the prior art, the command response changes from Not Ready to Ready when the device status changes from Not Ready to Ready. According to the present invention, however, the command response changes from Not Ready to Ready at the specified ready time ONLT, and if the device status is not yet ready (ready processing is not complete) at the maximum delay time MDT, then the command response returns to Not Ready, and the command response changes from Not Ready to Ready when the device status changes from Not Ready to Ready.

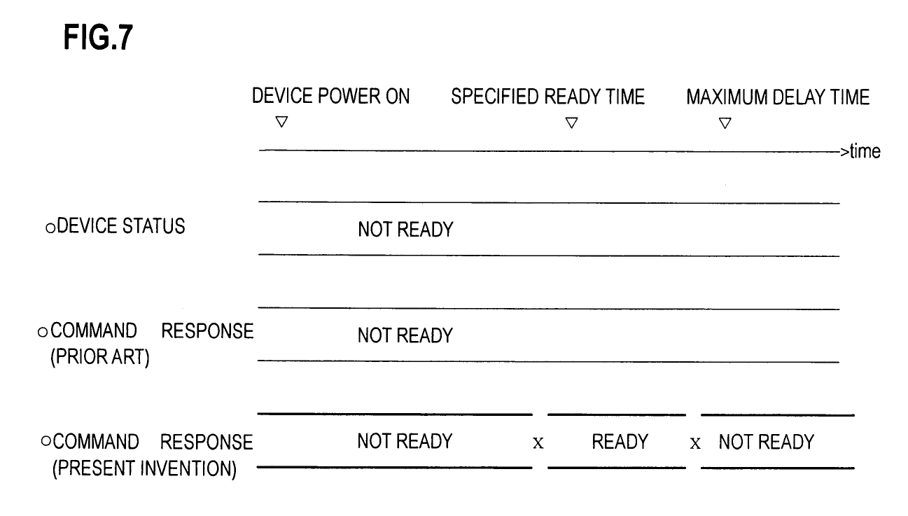

As FIG. 7 shows, if the device ready processing is not complete within the specified ready time ONLT and the maximum delay time MDT, the device status does not change from Not Ready to Ready. If the device status does not change from Not Ready to Ready even after this (startup failure), the command response does not change from Not Ready to Ready in the case of the prior art.

In the case of the present invention, however, the command response changes from Not Ready to Ready at the specified ready time ONLT, and if the device status does not become Ready even at the maximum delay time MDT (ready processing is not complete), then the command response returns to Not Ready, and this does not change to Ready unless the ready processing succeeds.

As described above, if the device status changes to Ready within the specified ready time from turning power ON (that is, ready processing succeeds), as shown in FIG. 4, the present invention executes a command response the same as in the prior art.

On the other hand, if the ready processing is not complete by the specified ready time due to retry, for example, as shown in FIG. 5, FIG. 6 and FIG. 7, the command response of the devices becomes ready after the ready processing is complete in the case of the prior art. This means that if the host issues an access command after the specified ready time elapses, Not Ready is responded, so the host changes the status to offline.

In the case of the present invention, on the other hand, the command response of the device is changed to Ready when the specified ready time comes, even if the ready processing is not complete within the specified ready time. Therefore if the host issues an access command after the specified ready time elapses, Ready is responded, so the host does not change the status to offline.

If the ready processing still is not complete when the maximum delay time MDT comes, as shown in FIG. 7, then the command response is returned to Not Ready. Therefore the host can recognize the failure of ready processing by the command response.

In the case of FIG. 6 and FIG. 7, an error is reported to the host when the maximum delay time MDT elapses, for the command received when the device status was Ready, as described later.

### Ready Processing

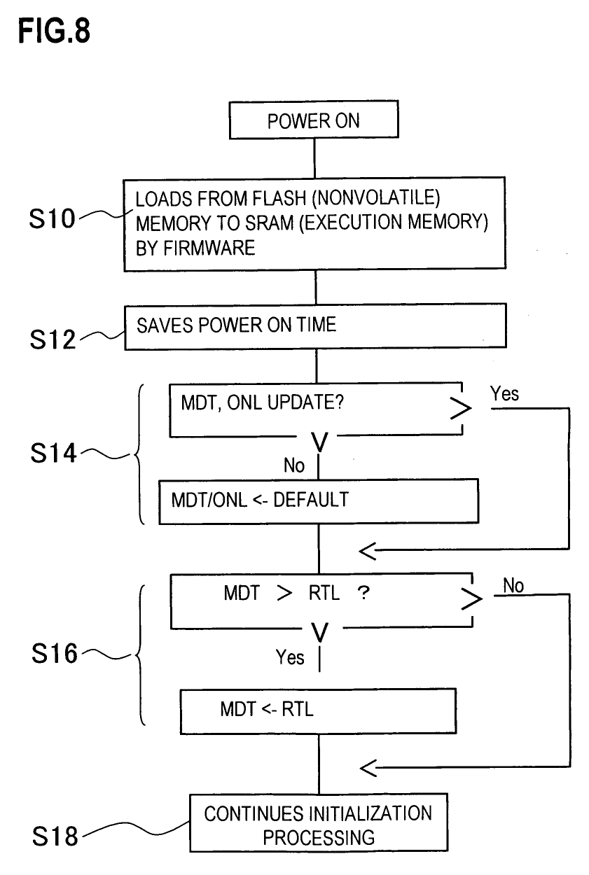

Now the above mentioned ready processing will be described in the sequence of processing immediately after power is turned ON, command receive processing and idle processing. FIG. 8 is a flow chart depicting the operation of the ready processing immediately after power is turned ON according to the present invention.

(S10) Micro codes onboard the device are stored in such a non-volatile memory 34 as a flash ROM. When power is turned ON, a micro code is copied to a volatile memory (e.g. SRAM), which is faster, in the MCU 28 by a boot code.

(S12) The MCU 28 saves the power ON time in a time area, which is not illustrated, in the SRAM by executing a micro code.

(S14) Then the MCU 28 judges whether the online timer (ONLT) 51 and the maximum delay time (MDT) 52 are updated. When executing an update, the values of the online timer (ONLT) 51 and the maximum delay time (MDT) 52 are updated to the update values being set. If an update is not performed, default values are set for the values of the online timer (ONLT) 51 and the maximum delay time (MDT) 52.

(S16) Then the MCU 28 judges whether the maximum delay time MDT exceeds the recovery limit time RLT. If it is judged that the maximum delay time MDT exceeds the recovery limit time RLT, the MCU 28 changes the maximum delay time MDT to the recovery limit time RLT.

(S18) Initialization processing starts when this boot processing is performed and the initial setting of the response parameters ends like this. In other words, the MCU 28 spins up the spindle motor 18, moves the magnetic head 12 from the CSS zone or the lamp to the system area of the magnetic disk 10, and the magnetic head 12 reads the data in the system area. And the MCU 28 sets the device to ready status. As mentioned above, retry is performed if a spin failure occurs, or if the moving of the magnetic head 10 fails.

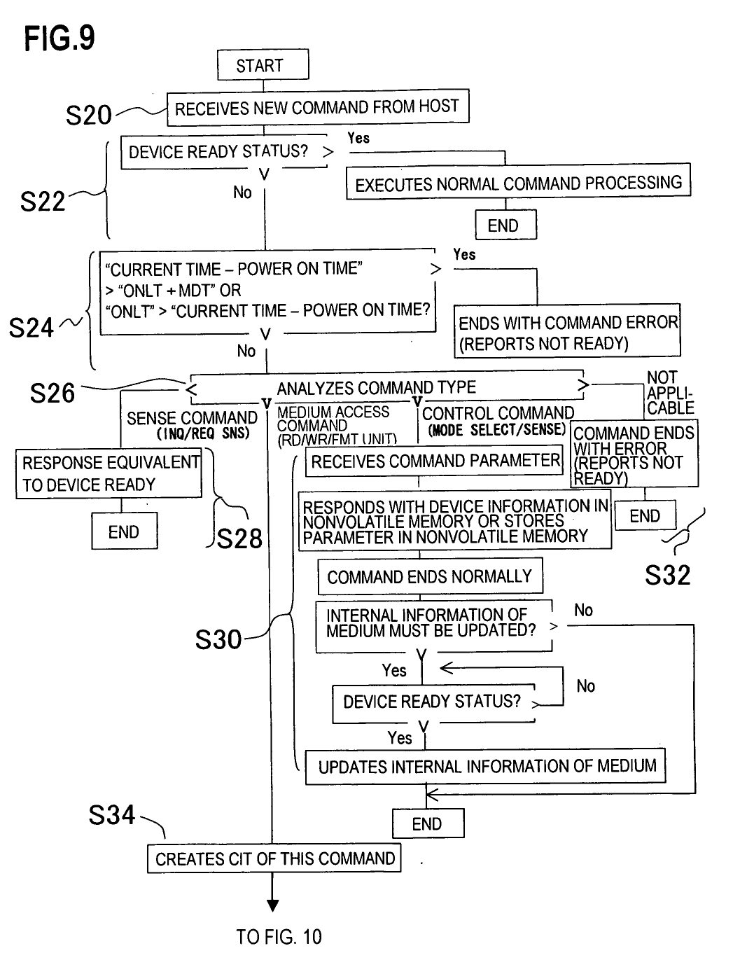

FIG. 9 is a flow chart depicting the command receive processing to be executed with the initialization processing in FIG. 8.

(S20) When the HDC 36 receives a command from the host, the HDC 36 notifies the receipt of this command to the MCU 28.

(S22) The MCU 28 checks whether the device is in ready status by executing a micro code. If the device is in ready status, the MCU 28 executes a normal command processing, and ends the processing.

(S24) If the device is not in ready status, the MCU 28 calculates the (current time−power ON time), and if the (current time−power ON time) exceeds the (specified ready time ONLT+maximum delay time MDT), or if the (current time−power ON time) is lesser than the ready time ONLT, the MCU 28 reports a command error (Not Ready) to the host.

(S26) If the (current time−power ON time) does not exceed the (specified ready time ONLT+maximum delay time MDT), and the (current time−power ON time) is not lesser than the ready time ONLT, in other words, if the time elapsed from when power ON is the “specified ready time” or longer and lesser than the “maximum delay time”, the MCU 28 analyzes the received command and executes the following processing according to the type of command.

(S28) If the received command is a sense command (e.g. Inquiry, Request Sense), the MCU 28 can execute the command regardless the initialization processing for the mechanism of the disk device. Therefore the MCU 28 reports that the device is ready to the host regardless the actual status of the device, and ends the processing.

(S30) If the received command is a control command (e.g. Mode Select, Log Select), the MCU 28 receives the command parameters and responds with the device information in the nonvolatile memory (FLASH) 40, or writes the parameters in the nonvolatile memory 40, and ends the command normally. After the command ends normally, the MCU 28 waits until the device becomes ready status, writes the necessary parameters on the disk medium (SA area) to update, and ends the processing. This command is, for example, changing the cache size or changing the retry method.

(S32) If the received command is a command other than a sense, control or medium access command, the MCU 28 ends the command with an error (reports the sense of Not Ready to the host), since this command is not applicable.

(S34) If the received command is a medium access command, such as read/write, then the MCU 28 creates a command information table CIT 53 for this command in the queue buffer.

(S36) The MCU 28 sets the NEXUS information, command information, VALID flag and Next CIT pointer, which are common information, (see FIG. 3) in the command information table 53.

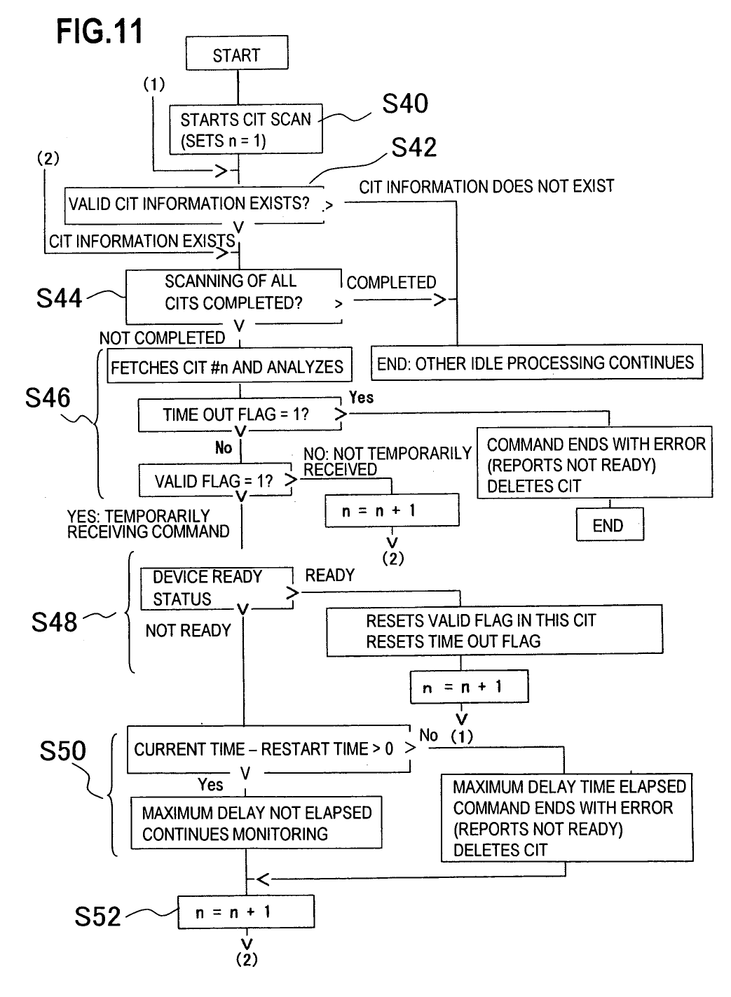

(S38) Then the MCU 28 calculates the command restart time. If the (current time−power ON time) in step S24 is lesser than the online timer time ONLT, the (power ON time+specified ready time+MDT time) is calculated as the command restart time, and if not lesser then the online timer time ONLT, the MCU 28 calculates the (command receive time (current time)+MDT time) as the command restart time. This command restart time is set in table 53. Also the MCU 28 sets a valid flag and resets a time out flag in table 53. And processing advances to idle processing in FIG. 11.

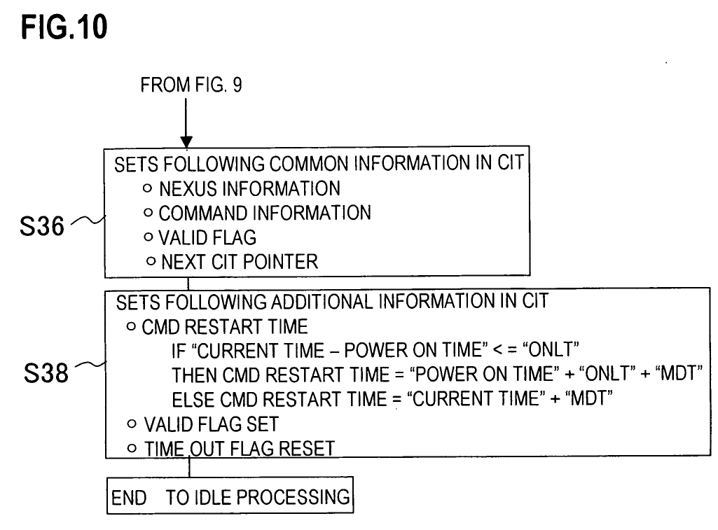

FIG. 11 is a flow chart depicting the idle processing continued from FIG. 10.

(S40) In idle processing, the MCU 28 scans whether valid CIT information exists in the CIT queue. Here the maximum number of CITs n is the maximum number of queueable commands (e.g. 128).

(S42) If there is no valid CIT information, the MCU 28 ends this routine, and continues with another idle processing.

(S44) If it is judged that there is valid CIT information, the MCU 28 judges whether all the CITs in the queue have been scanned. If the scanning of all CITs is completed, the MCU 28 ends this routine, and continues with another idle processing.

(S46) If it is judged that the scanning of all CITs has not been completed and that valid CIT information exists, the MCU 28 fetches this CIT information #n and analyzes it. In other words, it is judged whether a time out flag of the CIT information is “1”, and if there is CIT of which time out flag is “1”, the MCU 28 ends this command with an error, because the maximum delay time MDT elapsed since receiving this command, and deletes the CIT thereof (FIG. 6, FIG. 7). The reported sense to the host is Not Ready. If the time out flag is not “1”, it is judged whether the valid flag is “1”. If the valid flag is not “1”, which means this command is not a temporarily received command, the MCU 28 updates the scan pointer n to n+1, returns to step S44, and scans the next valid CIT.

(S48) If there is a CIT of which valid flag is “1”, the MCU 28 checks the current status of the device. If the current status of the device is Ready, the MCU 28 clears the valid flag and the time out flag in this CIT. At this point, normal execution of this command is enabled. Then the MCU 28 updates the scan pointer n to n+1, returns to step S42, and scans the next valid CIT.

(S50) If the current status is still Not Ready, the MCU 28 checks whether the current time passed the maximum command time (restart time). In other words, the MCU 28 calculates the (current time−restart time) and judges if the result is greater than “0”. If the (current time−restart time) is not greater than “0”, the MCU 28 judges that the current time passed the restart time, and sets the time out flag “1”, and ends this command with an error. The report sense to the host is Not Ready. Then this CIT is deleted. If the (current time−restart time) is greater than “0”, the MCU 28 judges that the current time has not passed the restart time, and continues monitoring the elapse of the maximum delay time.

(S52) Then the MCU 28 updates the scan pointer n to n+1, returns to step S44, and scans the next valid CIT. In other words, the MPU 28 executes the above steps for all the valid CITs.

Since the specified ready time is set and the host command is accepted if the specified ready time elapses, regardless the status of the device, even if the time from turning power ON to device ready status delays due to such a reason as retry of the spindle and head, the response of the device to the host can be executed without delay. Therefore the possibility of the host changing the status to offline due to a delay in startup can be decreased, and stable operation becomes possible.

If the received command is held until the maximum delay time, and if the device does not become ready status even if the maximum delay time elapses, an error is reported to the host, so even if a command is accepted before ready status, a report to the host according to ready processing is possible.

The maximum delay time MDT used by the device is originally calculated from a part of the allowable retry limit value RTL of the read/write command, and an increase in retry time in the entire device is suppressed to within an allowable range, and a drop in performance of the disk device is minimized.

### Other Embodiments

In the above embodiment, the medium storage device was described using an example of applying to a magnetic disk device, but the medium disk device can also be applied to other disk devices, such as an optical disk device, and a device using a rotating storage medium. The configuration of the controller was described using FIG. 1, but other configurations may be used.

The present invention was described above using embodiments, but the present invention can be modified in various ways within the scope of the spirit thereof, and these variant forms shall not be excluded from the scope of the present invention.

A specified ready time at which the ready processing is expected to be completed is set, and the command response of the device is changed to ready status when the specified ready time elapses, even if the ready processing is not complete within the specified ready time. Therefore when the host issues an access command after the specified ready time elapses, Ready is responded, so the host does not change the status to offline. If the ready processing still is not complete even if the maximum delay time elapses, the command response is returned to Not Ready. Therefore the host can recognize failure of ready processing by a command response.

What is claimed is:

1. A medium storage device, comprising:
a rotary motor for rotating a storage medium;
a head for at least reading data from the rotating storage medium; and
a control unit which executes a ready processing for enabling the head to access the storage medium after power is turned ON, executes retry of the ready processing if the ready processing does not succeed, and accepts a command from a host and enters ready status for executing the command if the ready processing succeeds,
wherein the control unit receives and accepts a command from the host when a specified ready time, at which a predetermined ready processing is expected to be completed after the power is turned ON, elapses and still the ready processing does not succeed.

2. The medium storage device according to claim 1, wherein the control unit stores a maximum delay time of an accepted command, and suspends execution of the accepted command until the maximum delay time elapses if the ready processing does not succeed before the maximum delay time elapses.

3. The medium storage device according to claim 2, wherein the control unit judges whether the accepted command is a medium access command for accessing the storage medium, and suspends execution of the accepted command until the maximum delay time elapses when judging that the accepted command is the medium access command.

4. The medium storage device according to claim 2, wherein the control unit reports an error to the host about the accepted command if the ready processing does not succeed even when the maximum delay time elapses.

5. The medium storage device according to claim 2, wherein the control unit executes the accepted command if the ready processing succeeds before the maximum delay time elapses.

6. The medium storage device according to claim 2, wherein the control unit comprises a queue buffer for queuing the accepted command,
and wherein the control unit stores the command accepted after the specified ready time and before the maximum delay time in the queue buffer with a temporal receive identifier attached.

7. The medium storage device according to claim 1, wherein the control unit creates a command information table of the command when the command is accepted from the host, and sets the temporal receive identifier, and a command restart time to indicate the maximum delay time of the command in the command information table.

8. The medium storage device according to claim 3, wherein the control unit judges whether the accepted command is a medium access command for accessing the storage medium, and executes the accepted command before the maximum delay time elapses when judging that the accepted command is not the medium access command.

9. A controller for a medium storage device which has a motor for rotating a storage medium, and a head for at least reading data from the rotating storage medium, the controller comprising:
a control unit which executes a ready processing for enabling the head to access the storage medium after power is turned ON, executes retry of the ready processing if the ready processing does not succeed, and accepts a command from a host and enters ready status for executing the command if the ready processing succeeds; and
a memory for storing a specified ready time at which a predetermined ready processing is expected to be completed after the power is turned ON,
wherein the control unit receives and accepts the command from the host if the specified ready time in the memory elapses and still the ready processing does not succeed.

10. The controller for a medium storage device according to claim 9, wherein the memory stores the maximum delay time of the accepted command, and the control unit suspends execution of the accepted command until the maximum delay time elapses if the ready processing does not succeed before the maximum delay time elapses.

11. The controller for a medium storage device according to claim 10, wherein the control unit judges whether the accepted command is a medium access command for accessing the storage medium, and suspends execution of the accepted command until the maximum delay time elapses when judging that the accepted command is the medium access command.

12. The controller for a medium storage device according to claim 10, wherein the control unit reports an error to the host about the accepted command if the ready processing does not succeed even when the maximum delay time elapses.

13. The controller for a medium storage device according to claim 10, wherein the control unit executes the accepted command if the ready processing succeeds before the maximum delay time elapses.

14. The controller for a medium storage device according to claim 10, further comprising a queue buffer for queuing the accepted command,
wherein the control unit stores the command accepted after the specified ready time and before the maximum delay time in the queue buffer with a temporal receive identifier attached.

15. The controller for a medium storage device according to claim 9, wherein the control unit creates a command information table of the command when the command is accepted from the host, and sets the temporal receive identifier and a command restart time to indicate the maximum delay time of the command in the command information table.

16. The controller for a medium storage device according to claim 11, wherein the control unit judges whether the accepted command is a medium access command for accessing the storage medium, and executes the accepted command before the maximum delay time elapses when judging that the accepted command is not the medium access command.

17. A startup processing method for a medium storage device which has a motor for rotating a storage medium, and a head for at least reading data from the rotating storage medium, the startup processing method comprising the steps of:
executing a ready processing for enabling the head to access the storage medium after power is turned ON;
executing retry of the ready processing if the ready processing does not succeed;
accepting a command from a host and executing the command if the ready processing succeeds; and
accepting the command from the host if a specified ready time, at which a predetermined ready processing is expected to be completed after the power is turned ON, elapses and still the ready processing does not succeed.

18. The startup processing method for a medium storage device according to claim 17, further comprising a step of suspending execution of the accepted command until the maximum delay time elapses if the ready processing does not succeed before the maximum delay time of the accepted command elapses.

19. The startup processing method for a medium storage device according to claim 18, further comprising:
a step of judging whether the accepted command is a medium access command for accessing the storage medium; and
a step of suspending execution of the accepted command until the maximum delay time elapses when judging that the accepted command is the medium access command.

20. The startup method for a medium storage device according to claim 18, further comprising a step of reporting an error to the host about the accepted command if the ready processing does not succeed even when the maximum delay time elapses.
